(19) United States
(12) Patent Application Publication
(10) Pub. No.: US 2014/0376393 A1
(43) Pub. Date: Dec. 25, 2014

(54) APPARATUS AND METHODS FOR DYNAMICALLY REPORTING INTER-SYSTEM MEASUREMENT CAPABILITY IN A WIRELESS COMMUNICATION NETWORK

(71) Applicant: QUALCOMM Incorporated, San Diego, CA (US)

(72) Inventors: Yongsheng Shi, San Diego, CA (US); Sathish Krishnamoorthy, Hyderabad (IN); Vikas Gulati, Hyderabad (IN); Satish Pavan Kumar Nichanametla, Hyderabad (IN); Liangchi Hsu, San Diego, CA (US)

(73) Assignee: QUALCOMM Incorporated, San Diego, CA (US)

(21) Appl. No.: 14/082,982

(22) Filed: Nov. 18, 2013

Related U.S. Application Data
(60) Provisional application No. 61/836,787, filed on Jun. 19, 2013.

(51) Int. Cl. H04W 24/06

(52) U.S. Cl. CPC H04W 24/06
USPC 370/252

(57) ABSTRACT

Aspects of the disclosure provide apparatus and methods of inter-system measurements operable at a user equipment (UE) in a wireless communication network. The UE establishes a connection with a network node in a first wireless communication network utilizing a first radio access technology (RAT), wherein the UE is capable of measuring a plurality of frequency bands of a second RAT greater in number than a measurement capability report limit of the first RAT. The UE further selects a subset of the plurality of frequency bands of the second RAT to be included in a measurement capability information element (IE) based on information provided by the network node and information stored at the UE. The UE further transmits the measurement capability IE to the network node.

### CROSS-REFERENCE TO RELATED APPLICATIONS

This application claims priority to and the benefit of provisional patent application No. 61/836,787 filed in the United States Patent Office on Jun. 19, 2013, the entire content of which is incorporated herein by reference.

### TECHNICAL FIELD

Aspects of the present disclosure relate generally to wireless communication systems, and more particularly, inter-system measurement reporting at a user equipment in a wireless communication network.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). UMTS also supports enhanced 3G data communications protocols, such as High Speed Packet Access (HSPA), which provides higher data transfer speeds and capacity to associated UMTS networks.

An example of an emerging telecommunication standard is Long Term Evolution (LTE). LTE is a set of enhancements to the UMTS mobile standard promulgated by 3GPP. It is designed to better support mobile broadband Internet access by improving spectral efficiency, lower costs, improve services, make use of new spectrum, and better integrate with other open standards using Orthogonal Frequency-Division Multiple Access (OFDMA) on the downlink (DL), SC-FDMA on the uplink (UL), and multiple-input multiple-output (MIMO) antenna technology. Therefore, a recent mobile terminal can support both W-CDMA and LTE using multiple frequency bands. Accordingly, it is desirable to improve the LTE band measurement reporting capability of the mobile terminal while it is camped on a W-CDMA network.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method of inter-system measurements at a user equipment (UE) in a wireless communication network. The UE establishes a connection with a network node in a first wireless communication network utilizing a first radio access technology (RAT), wherein the UE is capable of measuring a plurality of frequency bands of a second RAT greater in number than a measurement capability report limit of the first RAT. The UE selects a subset of the plurality of frequency bands of the second RAT to be included in a measurement capability information element (IE) based on information provided by the network node and information stored at the UE. The UE transmits the measurement capability IE to the network node.

Another aspect of the disclosure provides a user equipment (UE) for wireless communication. The UE includes a means for establishing a connection with a network node in a first wireless communication network utilizing a first radio access technology (RAT), wherein the UE is capable of measuring a plurality of frequency bands of a second RAT greater in number than a measurement capability report limit of the first RAT. The UE includes a means for selecting a subset of the plurality of frequency bands of the second RAT to be included in a measurement capability information element (IE) based on information provided by the network node and information stored at the UE. The UE further includes a means for transmitting the measurement capability IE to the network node.

Another aspect of the disclosure provides a computer-readable storage medium including code for causing a user equipment (UE) to perform various operations. The code causes the UE to establish a connection with a network node in a first wireless communication network utilizing a first radio access technology (RAT), wherein the user equipment (UE) is capable of measuring a plurality of frequency bands of a second RAT greater in number than a measurement capability report limit of the first RAT. The code causes the UE to select a subset of the plurality of frequency bands of the second RAT to be included in a measurement capability information element (IE) based on information provided by the network node and information stored at the UE. The code also causes the UE to transmit the measurement capability IE to the network node.

Another aspect of the disclosure provides a user equipment (UE) for wireless communication. The UE includes at least one processor, a communication interface coupled to the at least one processor, and a memory coupled to the at least one processor. The at least one processor includes a first circuitry configured to establish a connection with a network node in a first wireless communication network utilizing a first radio access technology (RAT), wherein the user equipment (UE) is capable of measuring a plurality of frequency bands of a second RAT greater in number than a measurement capability report limit of the first RAT. The at least one processor further includes a second circuitry configured to select a subset of the plurality of frequency bands of the second RAT to be included in a measurement capability information element (IE) based on information provided by the network node and information stored at the UE. The at least one processor further includes a third circuitry configured to transmit the measurement capability IE to the network node.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a conceptual diagram illustrating a wireless communication environment that includes one or more wireless devices such as a user equipment and wireless communication systems of different radio access technologies.

FIG. 2 is a conceptual diagram illustrating an example of a UMTS telecommunications system.

FIG. 3 is a conceptual diagram illustrating an example of a radio protocol architecture for the user and control plane.

FIG. 4 is a conceptual diagram illustrating an example of system information in UMTS organized as a tree.

FIG. 5 is a message flow diagram illustrating a procedure for selecting a subset of LTE frequency bands in a measurement capability information element during a radio resource control (RRC) connection establishment procedure in accordance with an aspect of the disclosure.

FIG. 6 is a flowchart illustrating a procedure for selecting LTE frequency bands in a measurement capability information element in accordance with aspects of the disclosure.

FIG. 7 is a flowchart illustrating a procedure for selecting LTE frequency bands based on a camped UMTS band in accordance with aspects of the disclosure.

FIG. 8 is a message flow diagram illustrating a measurement control procedure in accordance with an aspect of the disclosure.

FIG. 9 is a conceptual diagram illustrating an example of a hardware implementation for an apparatus employing a processing system in accordance with aspects of the disclosure.

FIG. 10 is a drawing illustrating a processor and a computer-readable medium of FIG. 9 in more detail in accordance with aspects of the disclosure.

FIG. 11 is a flowchart illustrating a method of performing inter-RAT measurements using a user equipment in a wireless communication network in accordance with an aspect of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the present disclosure are directed to a user equipment (UE) that has improved inter-system or inter-RAT (radio access technology) measurement capability. The UE may utilize a compressed mode (CM) (sometime referred to as the slotted mode) to make measurements from another frequency or band without using dual receivers. During the compressed mode, transmission and reception at the UE are halted for a short time (e.g., a few milliseconds) on the currently camped frequency in order to perform measurements on the other frequencies. Use of compressed mode depends on the UE's particular implementation and capability.

Some aspects of the disclosure are directed to a UE that can support multiple frequency bands using different radio access technologies (RATs) (e.g., W-CDMA and LTE). As defined in the current 3GPP specification Release 8 and onward (e.g., 3GPP Technical Specification 25.331), a UE can report its CM measurement capability up to sixteen LTE bands in a measurement capability information element (IE). Aspects of the present disclosure provide a solution to selectively include a subset of LTE bands in the measurement capability IE when the UE can measure more than 16 LTE bands. In some aspects of the disclosure, the UE selects the LTE bands in accordance with a number of rules that are applied in terms of their priorities.

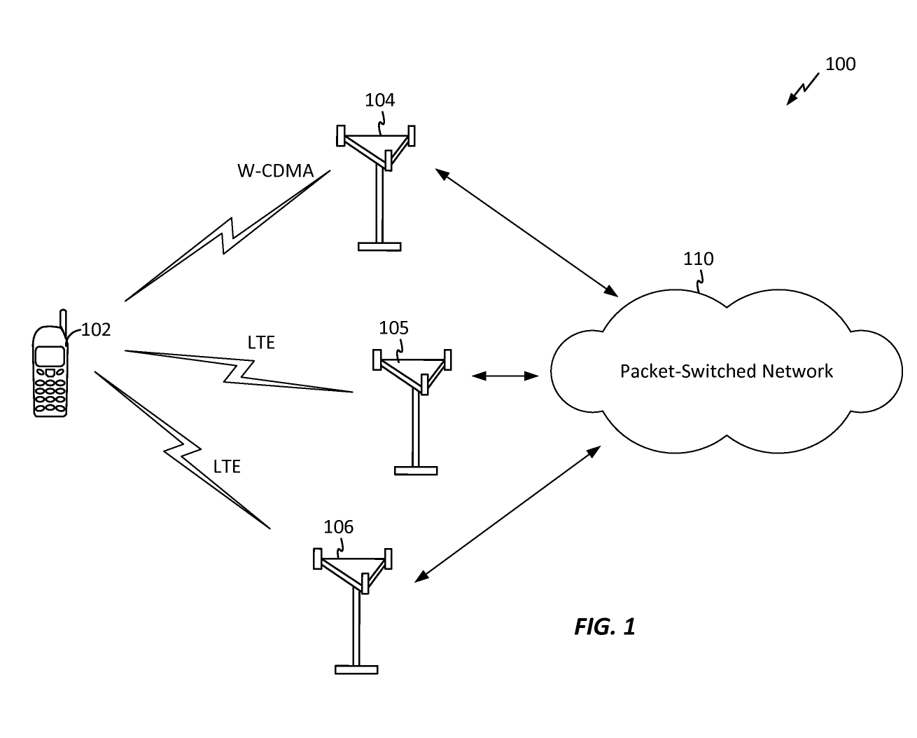

FIG. 1 conceptually illustrates a wireless communication environment 100 that includes one or more wireless devices such as a user equipment 102 and a number of wireless communication systems of different radio access technologies (e.g., W-CDMA and LTE). The user equipment (UE) 102 may be a cellular telephone, a smartphone, a tablet, a cordless telephone, a Session Initiation Protocol (SIP) phone, a personal digital assistant (PDA), a handheld device having wireless connection capability, a laptop computer, or other processing device connected to a wireless modem. The UE 102 may also be referred to as a subscriber unit, subscriber station, mobile station, mobile, mobile device, mobile terminal, remote station, remote terminal, access terminal (AT), user terminal, terminal, wireless communication device, user agent, or user device. The wireless communication systems (conceptually illustrated as systems 104, 105, and 106) provide the UE 102 with radio access to a wired core network, such as a packet-switched network 110 (e.g., Internet) or a circuit-switched network (e.g., public switched telephone network). Each of the systems 104, 105, and 106 may generally include one or more radio base stations (e.g., a Node B or eNode B) having multiple antenna groups and/or a transmitter/receiver chain that can in turn include a plurality of components associated with radio signal transmission and reception (e.g., processors, modulators, multiplexers, antennas, etc. (not shown)) to and from the UE 102. In one embodiment, the wireless communication systems 104, 105, and 106 may support W-CDMA and/or LTE.

In various aspects, the wireless communication environment 100 may include, but are not limited to, CDMA, TDMA, FDMA, OFDMA, SC-FDMA and other systems. The terms “system” and “network” are used interchangeably herein. A CDMA system may implement a radio access technology such as Universal Terrestrial Radio Access (UTRA), Evolved UTRA (E-UTRA), cdma2000, etc. UTRA includes W-CDMA and other variants of CDMA. E-UTRA includes LTE. Further, cdma2000 covers IS-2000, IS-95 and IS-856 standards. The present disclosure, however, is not limited to the radio access technologies disclosed herein. To the contrary, aspects of the disclosure may be applied with other wireless access technologies.

In an example, a UE 102 may be camped on a W-CDMA cell (e.g., system 104), and the UE 102 can measure LTE cells (e.g., systems 105 and 106) that are operated either on different frequency bands or even in the same band, but on a different part of the spectrum. The UE 102 may switch from one base station to another base station based on an estimated signal quality or characteristic. To estimate the signal quality/characteristic offered by a potential target base station, the UE 102 may take a Reference Signal Received Power (RSRP) and/or Reference Signal Received Quality (RSRQ) measurement of a reference or pilot signal transmitted by the target base station. In one example, the measurement quantities may be E-UTRA RSRQ or E-UTRA (RSRP).

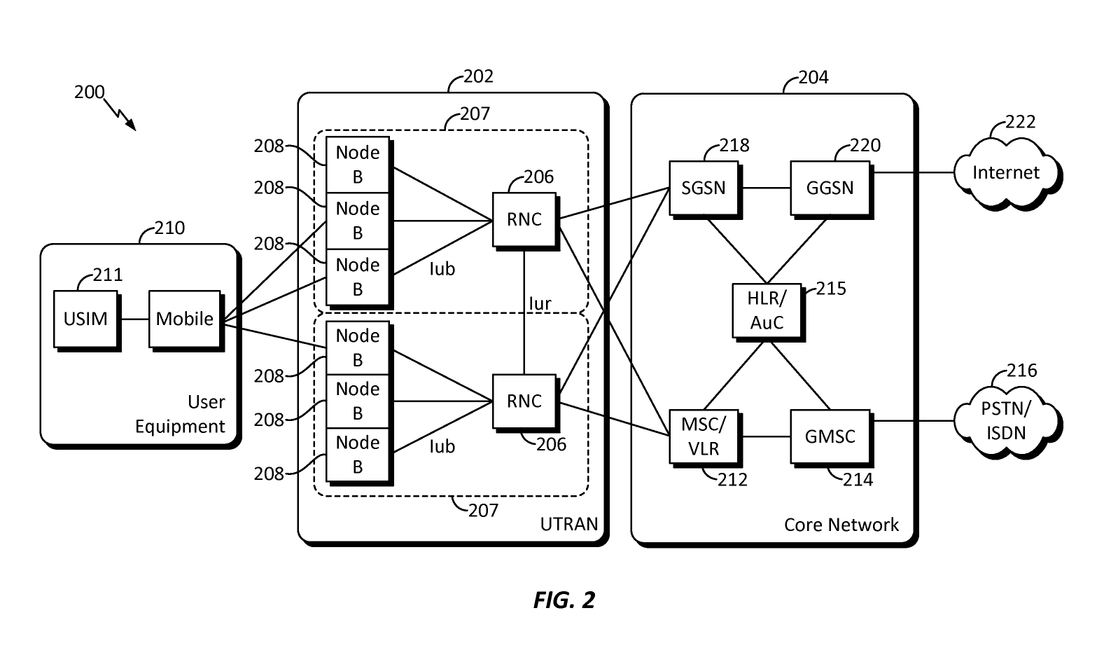

Referring now to FIG. 2, as an illustrative example without limitation, various aspects of the present disclosure are illustrated with reference to a Universal Mobile Telecommunications System (UMTS) system 200. The UMTS system 200 may be one of the systems 104, 105 and 106 in FIG. 1. A UMTS network includes three interacting domains: a core network 204, a radio access network (RAN) (e.g., the UMTS Terrestrial Radio Access Network (UTRAN) 202), and a user equipment (UE) 210. The UE 210 may be the UE 102 in FIG. 1 and supports both W-CDMA and LTE wireless access. Among several options available for a UTRAN 202, in this example, the illustrated UTRAN 202 may employ a W-CDMA air interface for enabling various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the illustrated RNCs 206 and RNSs 207. The RNC 206 is an apparatus responsible for, among other things, assigning, reconfiguring, and releasing radio resources within the RNS 207. The RNC 206 may be interconnected to other RNCs (not shown) in the UTRAN 202 through various types of interfaces such as a direct physical connection, a virtual network, or the like using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210 and the uplink (UL), also called the reverse link, refers to the communication link from a UE 210 to a Node B 208.

The core network 204 can interface with one or more access networks, such as the UTRAN 202. As shown, the core network 204 is a UMTS core network. However, as those skilled in the art will recognize, the various concepts presented throughout this disclosure may be implemented in a RAN, or other suitable access network, to provide UEs with access to types of core networks other than UMTS networks.

The illustrated UMTS core network 204 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The illustrated core network 204 also supports packet-switched data services with a serving GPRS support node (SGSN) 218 and a gateway GPRS support node (GGSN) 220. General Packet Radio Service (GPRS) is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

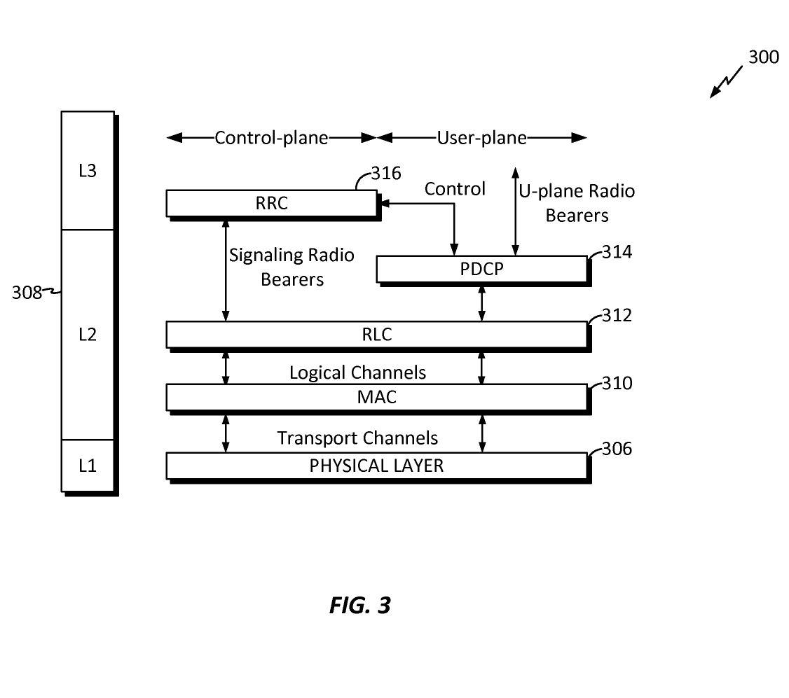

FIG. 3 is a drawing illustrating a communication protocol stack 300 in a UMTS system 200. The protocol stack 300 is divided into a Non-Access Stratum (NAS) and an Access Stratum (AS). The NAS provides the upper layers, for signaling between a UE 210 and a core network 204, and may include circuit switched and packet switched protocols. The AS provides the lower layers, for signaling between a UTRAN 202 and the UE 210, and may include a user plane and a control plane. Here, the user plane or data plane carries user traffic, while the control plane carries control information (i.e., signaling).

The AS is shown with three layers: Layer 1, Layer 2, and Layer 3. Layer 1 is the lowest layer and implements various physical layer signal processing functions. Layer 1 will be referred to herein as a physical layer 306. The data link layer, called Layer 2 308, is above the physical layer 306 and is responsible for the link between the UE 210 and a Node B 208 over the physical layer 306.

At Layer 3, a radio resource control (RRC) layer 316 handles the control plane signaling between the UE 210 and the Node B 208. The RRC layer 316 includes a number of functional entities for routing higher layer messages, handling broadcasting and paging functions, establishing configuring radio bearers, compressed mode control, etc.

In the illustrated air interface, the L2 layer 308 is split into sublayers. In the control plane, the L2 layer 308 includes two sublayers: a medium access control (MAC) sublayer 310 and a radio link control (RLC) sublayer 312. In the user plane, the L2 layer 308 additionally includes a packet data convergence protocol (PDCP) sublayer 314. Although not shown, the UE may have several upper layers above the L2 layer 308 including a network layer (e.g., IP layer) that is terminated at a PDN gateway on the network side and an application layer that is terminated at the other end of the connection (e.g., far end UE, server, etc.).

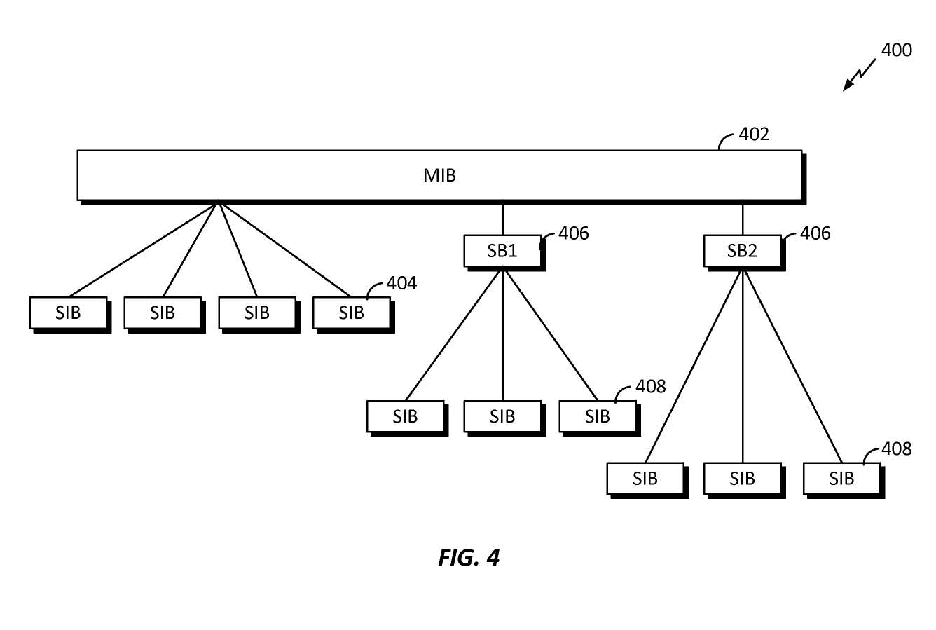

The RRC layer 316 handles the main part of the control signaling between the UEs (e.g., UE 210) and a UTRAN (e.g., UTRAN 202). The RRC layer 316 provides various functions including broadcast of system information related to AS and NAS, UE measurement reporting and control of the reporting, etc. The broadcast system information originates from the core network, from RNC and from Node Bs. An RRC System Information message carries system information blocks (SIBs), which group together system information elements of the same nature. One system information message can carry either several SIBs or only part of one SIB, depending on the size of the SIBs to be transmitted. Referring to FIG. 4, the system information is organized as a tree 400 with a Master Information Block (MIB) 402 as root, the MIB 402 contain references to a number of SIBs 404 and Scheduling Blocks (e.g., SB1 and SB2) 406. The Scheduling Blocks 406 contain references and scheduling information to additional SIBs 408. The SIBs contain all the actual system information.

In various aspects of the disclosure, a UE (e.g., UE 102, 210) may be controlled by an RNC (e.g., RNC 206) using RRC protocol messages, in terms of what to measure, when to measure and how to report, including both UTRA radio interface and other systems (e.g., E-UTRA). RRC signaling is also used to report the measurements from the UE to the RNC. The measurements control information may be included in the SIB type 12 and SIB type 11. In an example, the UE may measure and report LTE frequency bands utilizing the compressed mode that is controlled by the RRC layer. However, in the current UMTS standards (e.g., 3GPP; Technical Specification 25.331, Releases 8, 9 and 10), a UE can report up to sixteen LTE bands only even if the UE is capable of measuring more than sixteen LTE bands. This reporting limitation may be referred to as a measurement capability report limit in this specification.

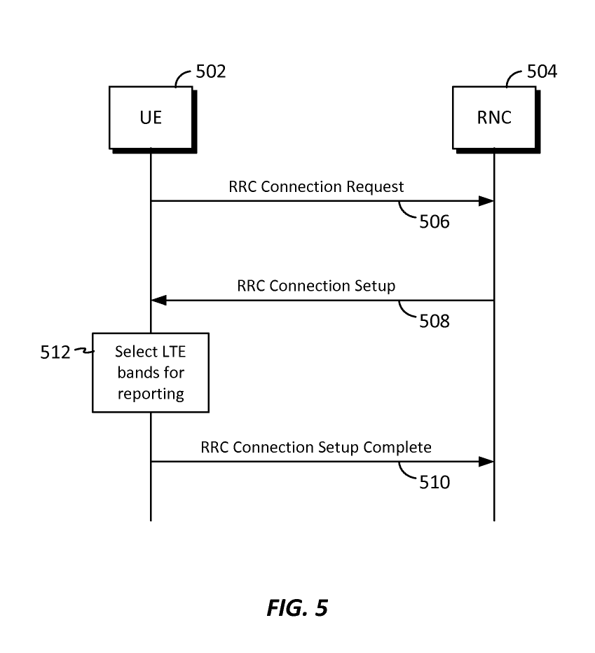

Aspects of the disclosure provide a solution to selectively include a subset (e.g., 16 or less) of LTE frequency bands in the measurement capability IE when a UE (e.g., UE 102) supports more than sixteen LTE frequency bands. When the UE supports more than sixteen LTE frequency bands, it applies a number of rules (e.g., prioritized rules) to selectively include a subset of the supported LTE frequency bands for capability reporting. In W-CDMA, the UE informs on its inter-system measurements capability as a part of the RRC Connection Setup Complete message. FIG. 5 is a message flow diagram illustrating a procedure for selecting a subset of LTE frequency bands in a measurement capability IE during an RRC connection establishment procedure in accordance with an aspect of the disclosure.

Referring to FIG. 5, the RRC layer at a UE 502 leaves an idle mode and initiates an RRC connection establishment procedure with an RNC 504 by sending an RRC Connection Request message 506. The UE 502 may be the UE 102 or 210, and the RNC 504 may be the RNC 206 (see FIGS. 1 and 2). On the network side, upon the reception of the RRC Connection Request message 506, the RRC layer of the RNC 504 performs admission control, assigns an s-RNTI for the RRC connection and selects radio resource parameters (such as transport channel type, transport format sets etc.). The selected parameters including the RNTI, are transmitted to the UE 502 in an RRC Connection Setup message 508. Upon reception of the RRC Connection Setup message 508, the RRC layer at the UE 502 configures the L1 and L2 layers using these parameters to locally establish the dedicated control channel (DCCH). Also, the RLC signaling link is locally established on both sides. When the UE has established the RLC signaling link, it transmits an RRC Connection Setup Complete message 510 back to the network. The RRC Connection Setup Complete message 510 includes a measurement capability IE that provides information on the UE's inter-RAT measurement capability (e.g., E-UTRA measurements and E-UTRA Frequency band). However, due to the reporting limitations (e.g., a measurement capability report limit) in the current UMTS standards, while the UE 502 may be capable of measuring frequency bands of a certain RAT (e.g., LTE) greater in number than a measurement capability report limit (e.g., 16 E-UTRA frequency bands), the UE 504 can only report up to sixteen E-UTRA (LTE) frequency bands. In aspects of the disclosure, the UE 502 may perform a procedure 512 to select or include a subset of LTE frequency bands in the measurement capability information element based on a number of rules applied in various priorities. However, the present disclosure is not limited to UMTS/LTE inter-system measurement, and may be applied in other radio access technologies.

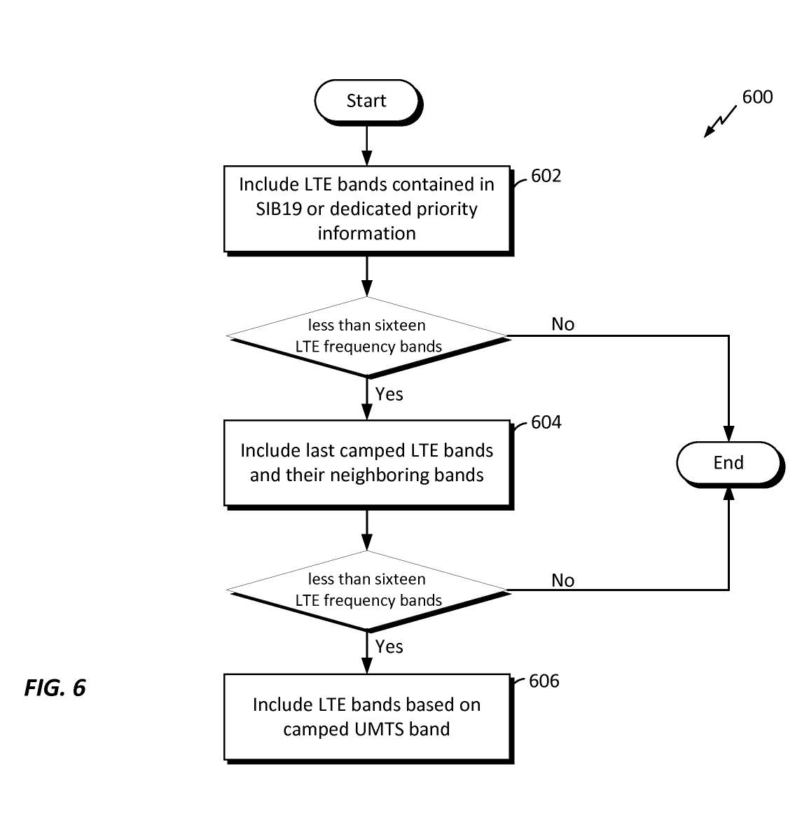

FIG. 6 is a flow chart illustrating a procedure 600 for selectively including LTE frequency bands in a measurement capability information element in accordance with aspects of the disclosure. The procedure 600 may correspond to the procedure 512 of FIG. 5. Referring to FIG. 6, in step 602, if the network (NT) (e.g., an RNC 502) broadcasts LTE frequency bands in SIB19 (as specified in the 3GPP standards, the SIB19 contains Inter-RAT frequency and priority information to be used in the cell), the UE includes the LTE frequency bands associated with the frequencies included in the E-UTRA Info List that provides different E-UTRA Frequency and Priority Information entries contained in the SIB19. In addition, if the network provides dedicated priority information containing LTE frequency bands, the UE includes the LTE frequency bands included in the dedicated priority information. In some examples, the UE may skip reading the SIB19 if deferred measurement control reporting (DMCR) is configured. Instead, the network can send the dedicated priority information to the UE using any suitable dedicated channels. In one aspect of the disclosure, the dedicated priority information may be sent in a Measurement Control message via a dedicated logical control channel. If less than sixteen LTE frequency bands are selected in step 602, the UE may proceed to step 604; otherwise, the procedure 600 ends.

In step 604, the UE include additional LTE frequency bands that the UE last camped on. For example, the UE may remember a number of LTE cells (e.g., last ten cells) it last camped on, and include the LTE frequency bands associated with these cells. In addition, the UE may include LTE frequency bands associated with the frequencies included in an SIB5 information element (e.g., InterFreqCarrierFreqList) of the last camped LTE cells. If a total of less than sixteen LTE frequency bands are selected in steps 602 and 604, the UE proceeds to step 606; otherwise, the procedure 600 ends.

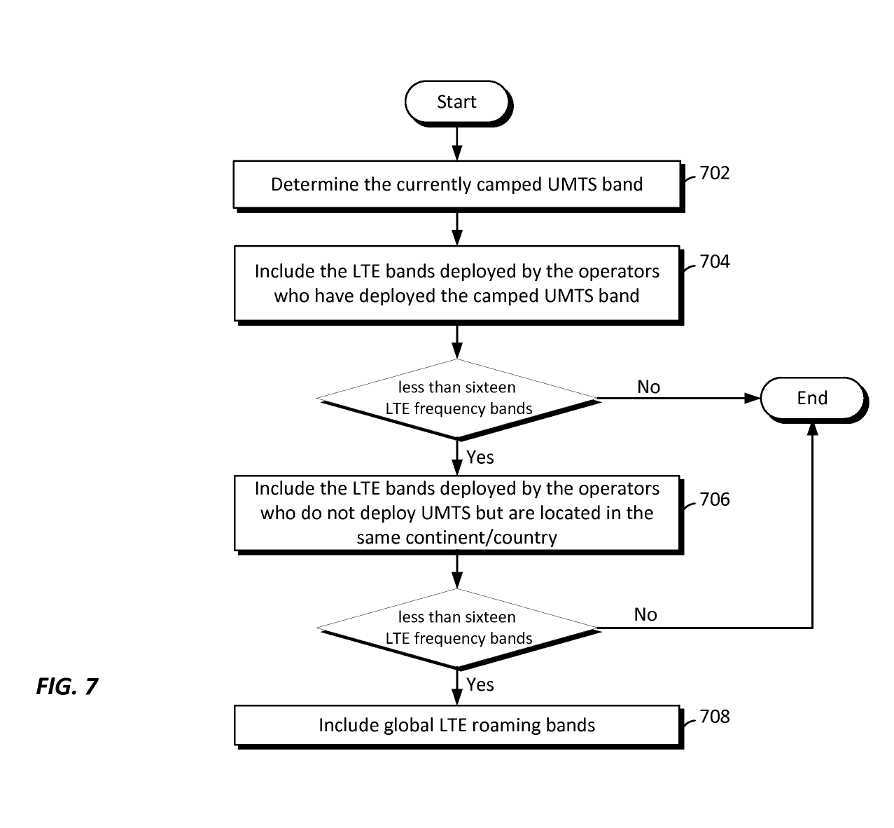

In step 606, the UE includes additional LTE frequency bands based on the currently camped UMTS band. The assumption is that each operator or region (e.g., continent/country) generally deploys a subset of all supported LTE bands and UMTS bands. Thus, the UE may select to report those LTE bands that are deployed within this operator's network or continent/country. FIG. 7 is a flowchart illustrating the step 606 in more detail in accordance with aspects of the disclosure. In step 702, the UE determines the current camped UMTS band (e.g., UMTS band 1). In step 704, the UE include the LTE frequency bands that are deployed by the operators who have deployed the currently camped UMTS band. For example, if the UE currently camps on UMTS band 1, the UE may include LTE bands 1, 3, 5, 7, 8, 19, 20, 21, 38, 40, and 41. If still less than sixteen LTE frequency bands are selected in total from all the previous steps, the UE may proceed to step 706; otherwise, the procedure ends.

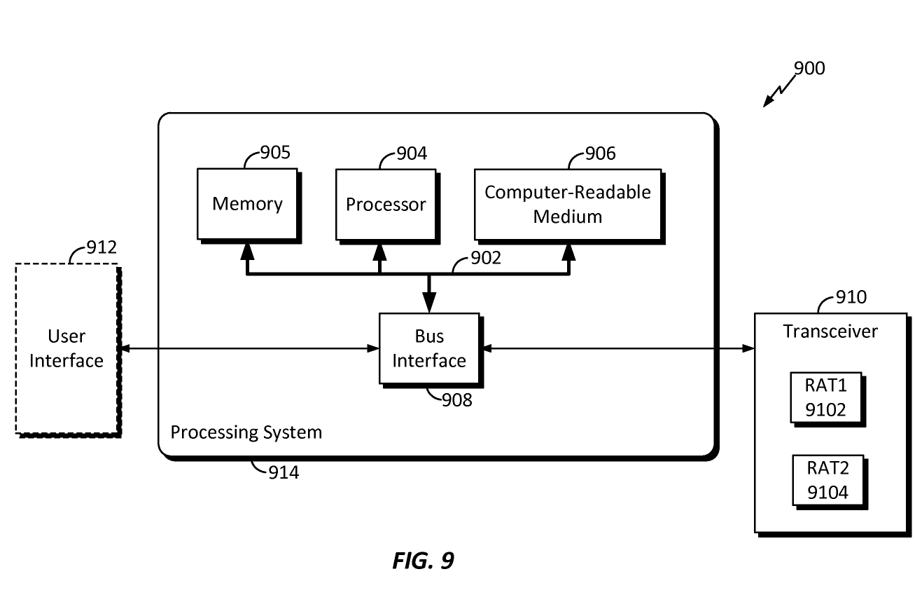

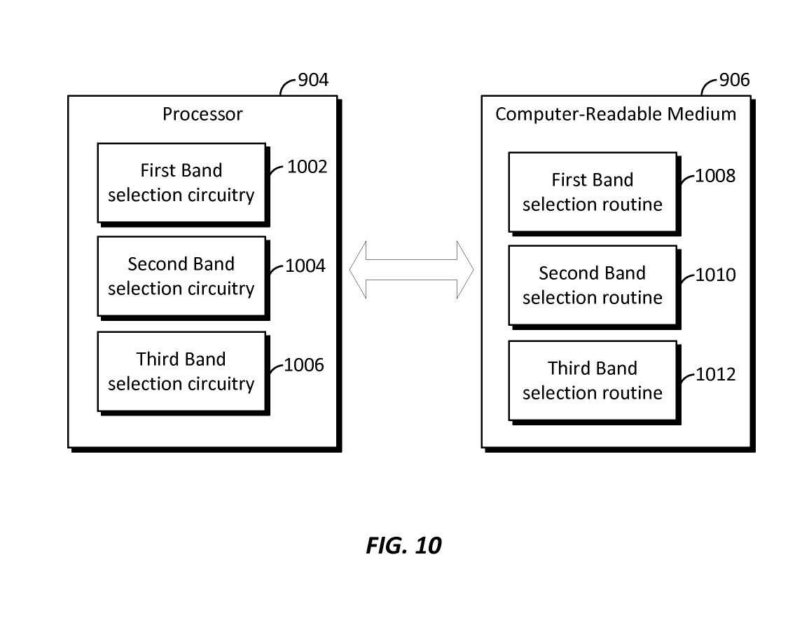

In step 706, the UE includes the LTE frequency bands deployed by the operators who do not deploy UMTS but are located in the same continent/country corresponding to the current camped UMTS band. For example, the UE may include LTE bands 11, 13, and 18, which are deployed by an operator who does not deploy UMTS in that location. If still less than sixteen LTE frequency bands are selected in total from all the previous steps, the UE may proceed to the next step 708; otherwise, the procedure ends. In step 708, the UE includes the LTE frequency bands that are considered as global roaming bands (e.g., band 28). In any of the steps in FIGS. 6 and 7, when the selected LTE frequency bands in a step will make the total number of included LTE frequency bands to exceed sixteen or a predetermined reporting limit, the UE may randomly include the LTE frequency bands available in that particular step up to a total of sixteen bands or the predetermined limit. In an aspect of the disclosure, the procedure 600 may be performed at a UE 102 or 210 that may be implemented as an apparatus 900 as illustrated in FIGS. 9 and 10. For example, the LTE frequency selection rules illustrated in FIGS. 6 and 7 may be performed by first band selection circuitry 1002, second band selection circuitry 1004, and/or third band selection circuitry 1006 of a processor 904 in the apparatus 900, which will be described in detail below.

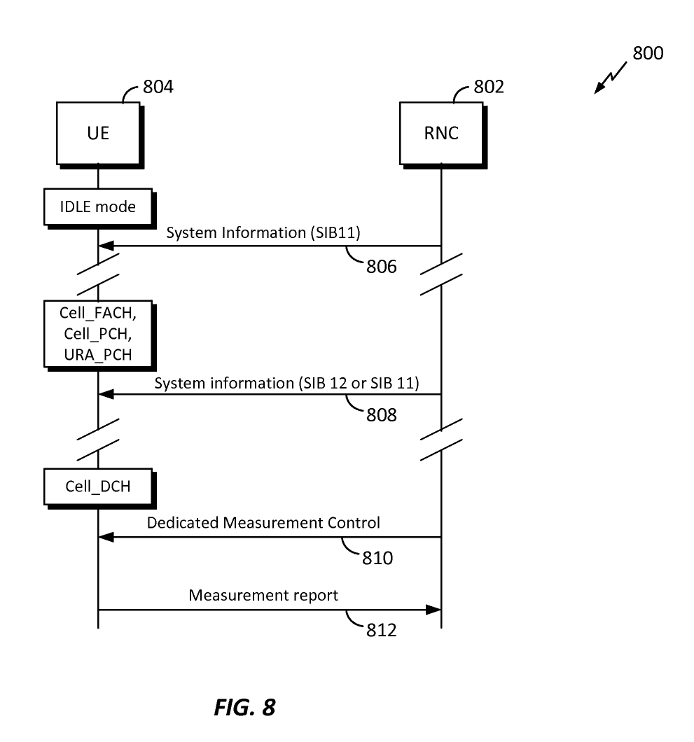

FIG. 8 is a message flow diagram illustrating a measurement control procedure 800 in accordance with an aspect of the disclosure. A serving RNC 802 may start, stop, or modify a number of measurements in an UE 804, and each of these measurements and their reports can be controlled independently of each other. The UE 804 may be the UE 102 or 210, and the RNC 802 may be the RNC 206 in FIG. 2. When the UE 804 is in an RRC idle mode, the RNC 802 may send measurement control information 806 contained in an SIB11. When the UE 804 is in a Cell_FACH (Forward access channel), Cell_PCH (Paging channel), or URA_PCH state of the RRC connected mode, the RNC 802 may send measurement control information contained in an SIB11 or SIB12. When the UE 804 is in a Cell_DCH (Dedicated channel) state, the RNC 802 may send a Dedicated Measurement Control message 810. The measurement control information includes various information such as the measurement types. One of the measurement types is inter-system measurements (e.g., Inter-RAT measurements on LTE bands). The measurement control information also includes measurement reporting criteria. The criteria trigger a measurement report 812 such as periodic or event-triggered reporting.

For example, the measurement control information may direct the UE 804 to perform inter-RAT measurements using a number of LTE frequency bands. In this case, the UE 804 may be able to support more than sixteen LTE frequency bands. In aspects of the disclosure, the UE 804 may perform the procedure 512 (see FIG. 5) to select or include a subset of all supported LTE frequency bands in its measurement capability report. After measurement, the UE 804 sends a Measurement Report message 812 including the measurement results to the RNC 802.

FIG. 9 is a conceptual diagram illustrating an example of a hardware implementation for an apparatus 900 employing a processing system 914. In accordance with various aspects of the disclosure, an element, or any portion of an element, or any combination of elements may be implemented with a processing system 914 that includes one or more processors 904. For example, the apparatus 900 may be a user equipment (UE) as illustrated in any one or more of FIGS. 1, 2, 5, and/or 8. In another example, the apparatus 900 may be a radio network controller (RNC) as illustrated in any one or more of FIGS. 2, 5, and/or 8. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. That is, the processor 904, as utilized in an apparatus 900, may be used to implement any one or more of the processes described below and illustrated in FIGS. 5-8.

In this example, the processing system 914 may be implemented with a bus architecture, represented generally by the bus 902. The bus 902 may include any number of interconnecting buses and bridges depending on the specific application of the processing system 914 and the overall design constraints. The bus 902 links together various circuits including one or more processors (represented generally by the processor 904), a memory 905, and computer-readable media (represented generally by the computer-readable medium 906). The bus 902 may also link various other circuits such as timing sources, peripherals, voltage regulators, and power management circuits, which are well known in the art, and therefore, will not be described any further. A bus interface 908 provides an interface between the bus 902 and a transceiver 910. The transceiver 910 provides a means for communicating with various other apparatus over transmission media. The transceiver 901 may include a first radio access technology (RAT) circuit 9102 for accessing a first wireless network (W-CDMA), and a second radio access technology circuit 9104 for accessing a second wireless network (LTE). Each of the RAT 9102 and RAT 9104 may include a transmitter and a receiver. Depending upon the nature of the apparatus, a user interface 912 (e.g., keypad, display, speaker, microphone, joystick, touchpad, touchscreen) may also be provided.

The processor 904 is responsible for managing the bus 902 and general processing, including the execution of software stored on the computer-readable medium 906. The software, when executed by the processor 904, causes the processing system 914 to perform the various functions described infra for any particular apparatus. The computer-readable medium 906 may also be used for storing data that is manipulated by the processor 904 when executing software.

One or more processors 904 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 906. The computer-readable medium 906 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 906 may reside in the processing system 914, external to the processing system 914, or distributed across multiple entities including the processing system 914. The computer-readable medium 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

FIG. 10 is a drawing illustrating the processor 904 and the computer-readable medium 906 in more detail according to aspects of the disclosure. The processor 904 may include first band selection circuitry 1002, second band selection circuitry 1004, and third band selection circuitry 1006. The first band selection circuitry 1002 may be configured to perform the procedures set forth in step 602. The second band selection circuitry 1004 may be configured to perform the procedures set forth in step 604. The third band selection circuitry 1006 may be configured to perform the procedures set forth in steps 606, 702, 704, 706, and 708. The computer-readable medium 906 may store a first band selection routine 1008, a second band selection routine 1010, and a third band selection routine 1012. The first band selection routine 1008 when executed by the processor 904 may configure the first band selection circuitry 1002 to perform the procedures set forth in step 602. The second band selection routine 1010 when executed by the processor 904 may configure the second band selection circuitry 1004 to perform the procedures set forth in step 604. The third band selection routine 1012 when executed by the processor 904 may configure the third band selection circuitry 1006 to perform the procedures set forth in steps 606, 702, 704, 706, and 708.

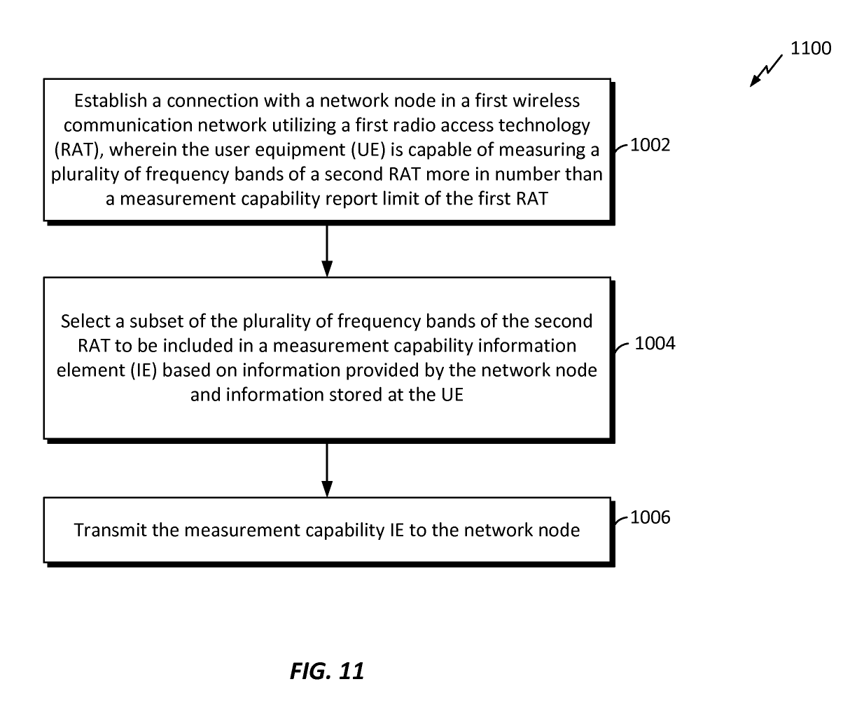

FIG. 11 is a flowchart illustrating a method 1100 of inter-system (e.g., inter-RAT) measurements at a user equipment in a wireless communication network in accordance with an aspect of the disclosure. In step 1002, an UE (e.g., UE 102, 210, 502, or 804) establishes a connection with a network node (e.g., RNC 206, 504, or 802) in a first wireless communication network utilizing a first radio access technology (RAT) (e.g., W-CDMA). Here, the UE is capable of measuring a plurality of frequency bands of a second RAT (e.g., LTE) greater in number than a measurement capability report limit of the first RAT. In an aspect of the disclosure, the processor 904 of the UE 900 may utilize the RAT circuit 9102 to access the first RAT and the RAT circuit 9104 to access the second RAT. In step 1004, the UE selects a subset of the plurality of frequency bands of the second RAT to be included in a measurement capability information element (IE) based on information provided by the network node and information stored at the UE. In an aspect of the disclosure, the subset of the plurality of frequency bands of the second RAT may be selected in accordance with a plurality of prioritized frequency selection rules (e.g., rules illustrated in FIGS. 6 and 7). In an aspect of the disclosure, the processor 904 may execute the first, second and third band selection routines (1008, 1010, and 1012) to configure the first, second and third band selection circuitries (1002, 1004, and 1006), respectively, to perform the various functionalities of step 1004. In step 1006, the UE transmits the measurement capability IE to the network node. In an aspect of the disclosure, the processor 904 may utilize the RAT circuit 9102 to transmit the measurement capability IE.

Several aspects of a telecommunications system have been presented with reference to a W-CDMA/LTE system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of inter-system measurements at a user equipment (UE) in a wireless communication network, comprising:
establishing a connection with a network node in a first wireless communication network utilizing a first radio access technology (RAT), wherein the UE is capable of measuring a plurality of frequency bands of a second RAT greater in number than a measurement capability report limit of the first RAT;
selecting a subset of the plurality of frequency bands of the second RAT to be included in a measurement capability information element (IE) based on information provided by the network node and information stored at the UE; and
transmitting the measurement capability IE to the network node.

2. The method of claim 1, wherein the subset of the plurality of frequency bands of the second RAT is selected in accordance with a plurality of prioritized frequency selection rules comprising:
a first rule for selecting frequency bands of the second RAT indicated by the network node;
a second rule for selecting frequency bands of the second RAT on which the UE previously camped on, and one or more associated frequency bands; and
a third rule for selecting frequency bands of the second RAT based on a frequency band of the first RAT.

3. The method of claim 2, wherein the first rule has a priority higher than that of the second rule, and the second rule has a priority higher than that of the third rule.

4. The method of claim 2, wherein for the first rule, the frequency bands of the second RAT indicated by the network node are included in a system information block (SIB).

5. The method of claim 4, wherein the SIB comprises an SIB 19.

6. The method of claim 2, wherein for the second rule, the one or more associated frequency bands comprise frequency bands included in an SIBS.

7. The method of claim 2, wherein the third rule comprises:
determining a region or an operator based on a frequency band of the first RAT on which the UE is currently camped on; and
selecting one or more frequency bands of the second RAT deployed in the region or by the operator based on the information stored at the UE.

8. The method of claim 7, wherein the operator deploys both the frequency band of the first RAT and the selected one or more frequency bands of the second RAT.

9. The method of claim 7, wherein the operator deploys the selected one or more frequency bands of the second RAT, but not the frequency band of the first RAT.

10. The method of claim 7, wherein the third rule further comprises:
selecting one or more frequency bands of the second RAT corresponding to global roaming bands.

11. The method of claim 1, wherein the first RAT is Wideband-Code Division Multiple Access, and the second RAT is Long Term Evolution.

12. A user equipment for wireless communication, comprising:
means for establishing a connection with a network node in a first wireless communication network utilizing a first radio access technology (RAT), wherein the user equipment (UE) is capable of measuring a plurality of frequency bands of a second RAT greater in number than a measurement capability report limit of the first RAT;
means for selecting a subset of the plurality of frequency bands of the second RAT to be included in a measurement capability information element (IE) based on information provided by the network node and information stored at the UE; and
means for transmitting the measurement capability IE to the network node.

13. The user equipment of claim 12, wherein the subset of the plurality of frequency bands of the second RAT is selected in accordance with a plurality of prioritized frequency selection rules comprising:
a first rule for selecting frequency bands of the second RAT indicated by the network node;
a second rule for selecting frequency bands of the second RAT on which the UE previously camped on, and one or more associated frequency bands; and
a third rule for selecting frequency bands of the second RAT based on a frequency band of the first RAT.

14. The user equipment of claim 13, wherein the first rule has a priority higher than that of the second rule, and the second rule has a priority higher than that of the third rule.

15. The user equipment of claim 13, wherein for the first rule, the frequency bands of the second RAT indicated by the network node comprise frequency bands included in a system information block (SIB).

16. The user equipment of claim 15, wherein the SIB comprises an SIB19.

17. The user equipment of claim 13, wherein for the second rule, the one or more associated frequency bands comprise frequency bands included in an SIBS.

18. The user equipment of claim 13, wherein the third rule comprises:
determining a region or an operator based on a frequency band of the first RAT on which the UE is currently camped on; and
selecting one or more frequency bands of the second RAT deployed in the region or by the operator based on the information stored at the UE.

19. A computer-readable storage medium comprising:
code for causing a user equipment (UE) to:
establish a connection with a network node in a first wireless communication network utilizing a first radio access technology (RAT), wherein the user equipment (UE) is capable of measuring a plurality of frequency bands of a second RAT greater in number than a measurement capability report limit of the first RAT;
select a subset of the plurality of frequency bands of the second RAT to be included in a measurement capability information element (IE) based on information provided by the network node and information stored at the UE; and
transmit the measurement capability IE to the network node.

20. A user equipment (UE) for wireless communication, comprising:
at least one processor;
a communication interface coupled to the at least one processor; and
a memory coupled to the at least one processor,
wherein the at least one processor comprises:
first circuitry configured to establish a connection with a network node in a first wireless communication network utilizing a first radio access technology (RAT), wherein the user equipment (UE) is capable of measuring a plurality of frequency bands of a second RAT greater in number than a measurement capability report limit of the first RAT;
second circuitry configured to select a subset of the plurality of frequency bands of the second RAT to be included in a measurement capability information element (IE) based on information provided by the network node and information stored at the UE; and
third circuitry to transmit the measurement capability IE to the network node.

21. The user equipment of claim 20,
wherein the subset of the plurality of frequency bands of the second RAT is selected in accordance with a plurality of prioritized frequency selection rules comprising:
a first rule for selecting frequency bands of the second RAT indicated by the network node;
a second rule for selecting frequency bands of the second RAT on which the UE previously camped on, and one or more associated frequency bands; and
a third rule for selecting frequency bands of the second RAT based on a frequency band of the first RAT.

22. The user equipment of claim 21, wherein the first rule has a priority higher than that of the second rule, and the second rule has a priority higher than that of the third rule.

23. The user equipment of claim 21, wherein for the first rule, the frequency bands of the second RAT indicated by the network node comprise frequency bands included in a system information block (SIB).

24. The user equipment of claim 23, wherein the SIB comprises an SIB19.

25. The user equipment of claim 21, wherein for the second rule, the one or more associated frequency bands comprise frequency bands included in an SIBS.

26. The user equipment of claim 21, wherein the third rule comprises:
determining a region or an operator based on the frequency band of the first RAT on which the UE is currently camped on; and
selecting one or more frequency bands of the second RAT deployed in the region or by the operator based on the information stored at the UE.

27. The user equipment of claim 26, wherein the operator deploys both the frequency band of the first RAT and the selected one or more frequency bands of the second RAT.

28. The user equipment of claim 26, wherein the operator deploys the selected one or more frequency bands of the second RAT, but not the frequency band of the first RAT.

29. The user equipment of claim 26, wherein the third rule further comprises:
selecting one or more frequency bands of the second RAT corresponding to global roaming bands.

30. The user equipment of claim 20, wherein the first RAT is Wideband-Code Division Multiple Access, and the second RAT is Long Term Evolution.
